(19) United States
(12) Patent Application Publication
(10) Pub. No.: US 2025/0098765 A1
(43) Pub. Date: Mar. 27, 2025

(54) ATOMIZATION ASSEMBLY AND ASSEMBLY METHOD THEREFORE, AND AEROSOL GENERATION APPARATUS

(71) Applicant: SHENZHEN FIRST UNION TECHNOLOGY CO., LTD., Shenzhen, Guangdong (CN)

(72) Inventors: Xiaowen DAI, Shenzhen, Guangdong (CN); Chongjiu HU, Shenzhen, Guangdong (CN); Jingfu LONG, Shenzhen, Guangdong (CN); Xueqiang ZHAN, Shenzhen, Guangdong (CN); Ganzhou LI, Shenzhen, Guangdong (CN); Junrong LIANG, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 18/729,567

(22) PCT Filed: Jan. 10, 2023
(86) PCT No.: PCT/CN2023/071623

§ 371 Date: Jul. 17, 2024

(30) Foreign Application Priority Data
Jan. 18, 2022 (CN) 202210052294.7

(51) Int. Cl. A24F 40/46; A24F 40/10; A24F 40/44; A24F 40/70; H05B 3/44

(52) U.S. Cl. CPC A24F 40/46; A24F 40/10; A24F 40/44; A24F 40/70; H05B 3/44; H05B 2203/016; H05B 2203/021

(57) ABSTRACT

A tubular atomization assembly, an assembly method and an aerosol generation apparatus are provided. The atomization assembly includes a heating element, a sleeve and an insulation base. The heating element includes a heating portion and a conductive portion having a first conductive portion and a second conductive portion. The sleeve has a hollow accommodating cavity, in which the heating portion is accommodated. At least a part of the conductive portion extends to an exterior of the accommodating cavity. The insulation base is connected to one end of the sleeve and includes a perforation. The first conductive portion and the second conductive portion run through the perforation to be fixed on the insulation base. The first conductive portion and the second conductive portion can be kept together or close to each other to be inserted into the same perforation, without applying a pulling force to the heating portion.

### CROSS-REFERENCE TO RELATED APPLICATIONS

This application claims priority to Chinese Patent Application No. 202210052294.7, entitled “ATOMIZATION ASSEMBLY AND ASSEMBLY METHOD THEREFORE, AND AEROSOL GENERATION APPARATUS” filed on Jan. 18, 2022, which is incorporated herein by reference in its entirety.

### TECHNICAL FIELD

Embodiments of this application relate to the field of aerosol generation apparatuses, and in particular, to an atomization assembly and an assembly method therefor, and an aerosol generation apparatus.

### BACKGROUND

A core assembly of an aerosol generation apparatus is an atomization assembly. The atomization assembly can atomize a liquid substrate stored in the aerosol generation apparatus, to generate an aerosol. In the related art, the atomization assembly includes a heating element, a liquid guide element, and a support assembly. A tubular atomization assembly is widely used in the aerosol generation apparatus due to a small entire volume. A heating portion of the heating element is mainly a sheet heating mesh, and the liquid guide element is made of fiber cotton. However, the heating element and the liquid guide element have soft texture. In a process of mounting the heating element and the liquid guide element to the support assembly with hard texture, the heating portion of the heating element tends to move due to pulling by conductive pins at two ends, affecting quality of the aerosol generated by the aerosol generation apparatus, and making it impossible to use the atomization assembly in an automated assembly line.

### SUMMARY

To resolve the problem in the related art, embodiments of this application provide an atomization assembly that can facilitate fixing of a heating element, and an aerosol generation apparatus.

According to an aspect, this application provides a tubular atomization assembly, including a heating element, including a heating portion and a conductive portion electrically connected to the heating portion, where the conductive portion includes a first conductive portion and a second conductive portion, and the heating portion is connected between the first conductive portion and the second conductive portion; a sleeve, having a hollow accommodating cavity, where the heating portion of the heating element is accommodated in the accommodating cavity, and the conductive portion extends to an exterior of the accommodating cavity; and an insulation base, connected at one end of the sleeve, where the insulation base includes a perforation, and the first conductive portion and the second conductive portion run through the perforation to be fixed on the insulation base.

In some embodiments, the atomization assembly further includes a fixing ring around an exterior of the insulation base.

In some embodiments, the heating element includes a heating sheet with a mesh structure, and the heating portion is constructed into an unclosed tube-like structure.

In some embodiments, the first conductive portion includes a first conductive lead, and the second conductive portion includes a second conductive lead. The first conductive lead and the second conductive lead are positioned on the insulation base, and a distance between the first conductive lead and the second conductive lead is not greater than a distance between two free sides of the heating element.

In some embodiments, a spacing region is provided between the two free sides of the heating portion, and the perforation is substantially flush with the spacing region in a longitudinal direction.

In some embodiments, at least one U-shaped opening is provided on a side surface of the sleeve.

In some embodiments, the opening includes a first opening and a second opening that are spaced apart. At least one liquid guide hole is further provided between the first opening and the second opening.

In some embodiments, a rib is provided on the insulation base, and a size of the rib is configured to be inserted into the opening.

In some embodiments, the rib is located at a position on an outer surface of the insulation base corresponding to the perforation.

In some embodiments, the insulation base further includes a through hole. The through hole is coaxially provided with the accommodating cavity.

In some embodiments, the perforation is provided on a side of the through hole, and a separation wall is arranged between the through hole and the perforation.

In some embodiments, the atomization assembly further includes a liquid guide element arranged at least partially around the heating element. The liquid guide element includes a protruding structure. The protruding structure is accommodated in the opening.

In some embodiments, the atomization assembly further includes a liquid guide element arranged at least partially around the heating element. The liquid guide element abuts longitudinally against the insulation base.

In some embodiments, the liquid guide element includes a protruding structure, and a size of the opening is configured to accommodate the protruding structure of the liquid guide element and at least a part of the rib of the insulation base.

In some embodiments, the insulation base includes a flange, and one end of the flange abuts against the sleeve.

In some embodiments, the fixing ring abuts against an other end of the flange.

According to a second aspect, an embodiment of this application further provides an assembly method for the atomization assembly. The assembly method includes winding a heating element and a liquid guide element around a cotton-wrapped stick, to form a first assembly; inserting the first assembly into an accommodating cavity of a sleeve from one end of the sleeve; and connecting an insulation base to the same end of the sleeve, and accommodating two conductive portions of the heating element in a perforation of the insulation base.

In some embodiments, the assembly method further includes riveting a fixing ring on the insulation base.

According to a third aspect, an embodiment of this application provides an aerosol generation apparatus, including a housing. A liquid storage cavity for storing a liquid substrate and an atomization assembly are provided in the housing. The atomization assembly includes the above atomization assembly, and the atomization assembly can atomize the liquid substrate to generate an aerosol.

This application has the following beneficial effects: Because the first conductive portion and the second conductive portion are fixed in the same perforation on the insulation base, that is, the first conductive portion and the second conductive portion can be kept together or close to each other to be inserted into the same perforation, the first conductive portion and the second conductive portion do not apply a pulling force to the heating portion of the heating element in a fixing process, so that the heating portion of the heating element can be fixed in the accommodating cavity of the sleeve according to a predetermined fixed position.

### BRIEF DESCRIPTION OF THE DRAWINGS

One or more embodiments are exemplarily described with reference to the corresponding figures in the accompanying drawings, and the exemplary descriptions are not to be construed as limitation on the embodiments. Elements in the accompanying drawings that have same reference numerals are represented as similar elements, and unless otherwise particularly stated, the figures in the accompanying drawings are not drawn to scale.

FIG. 1 is a cross-sectional view of an aerosol generation apparatus according to an embodiment of this application;

FIG. 2 is a three-dimensional view of an atomization assembly according to an embodiment of this application;

FIG. 3 is an exploded view of the atomization assembly according to an embodiment of this application;

FIG. 4 is a cross-sectional view of the atomization assembly according to an embodiment of this application;

FIG. 5 is a three-dimensional view of a sleeve according to an embodiment of this application;

FIG. 6 is a three-dimensional view of an insulation base according to an embodiment of this application;

FIG. 7 is a three-dimensional view of a heating element according to an embodiment of this application;

FIG. 8A is a schematic diagram of assembly step 1 of the atomization assembly according to an embodiment of this application;

FIG. 8B is a schematic diagram of assembly step 2 of the atomization assembly according to an embodiment of this application;

FIG. 8C is a schematic diagram of assembly step 3 of the atomization assembly according to an embodiment of this application; and

FIG. 8D is a schematic diagram of assembly step 4 of the atomization assembly according to an embodiment of this application.

### DETAILED DESCRIPTION

For ease of understanding this application, this application is described below in more detail with reference to accompanying drawings and specific implementations.

It should be noted that all the directional indicators (for example, upper, lower, left, right, front, rear, horizontal, and vertical) in the embodiments of this application are merely used to explain a relative position relationship, a motion status, and the like between components in a specific state (as shown in the accompanying drawings). If the specific state changes, the directional indicator correspondingly changes, the “connection” may be direct connection or indirect connection, and the “arranged”, “arranged in”, and “provided in” may be direct or indirect.

In addition, descriptions involving “first”, “second”, and the like in this application are merely used for a purpose of description, and shall not be understood as an indication or implication of relative importance or implicit indication of a quantity of indicated technical features. Therefore, a feature defined by “first” or “second” can explicitly or implicitly include at least one of the features.

This application provides an aerosol generation apparatus, including a liquid storage component, an atomization assembly, a power supply assembly, and other support assemblies. The power supply assembly mainly includes a battery and an airflow sensing switch assembly. The battery is electrically connected to the atomization assembly, to provide electric drive for the atomization assembly. The liquid storage component may be formed by a part of an inner cavity of a housing of the aerosol generation apparatus, or may be a separate liquid storage container. A liquid substrate stored in the liquid storage component can flow to the atomization assembly, and the atomization assembly atomizes the liquid substrate to generate an aerosol. Based on different liquid substrates stored in the liquid storage component, aerosol generation apparatuses may be classified into electronic cigarettes and medical equipment. The liquid substrate stored in the electronic cigarettes generally includes nicotine products. After being atomized, the liquid substrate stored in the medical equipment can generate an aerosol with therapeutic effects on respiratory diseases.

The aerosol generation apparatus may be configured as two detachably connected assemblies. One assembly is an atomizer, and the other one is a power supply assembly. Such aerosol generation apparatus is referred to as an aerosol generation apparatus of a replaceable atomizer type. The power supply assembly includes a rechargeable battery, and a control module may be further arranged in the power supply assembly. The atomizer mainly includes the atomization assembly and a liquid storage component. After the liquid substrate is consumed, a service life of the atomizer ends, and a new atomizer can be connected to the power supply component for use. In another embodiment, the aerosol generation apparatus is configured as a whole, and the battery and the atomization assembly are accommodated in one housing. Such aerosol generation apparatus is generally referred to as a disposable aerosol generation apparatus. The disposable aerosol generation apparatus has a small volume and is convenient for users to carry.

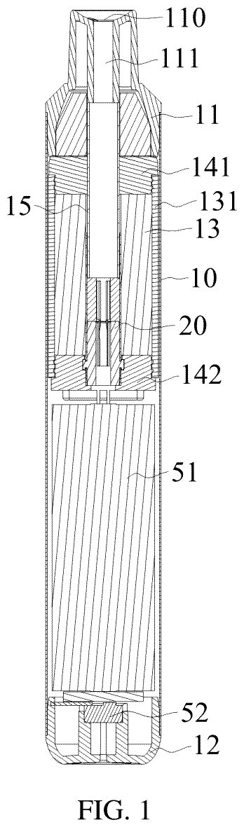

A cylindrical disposable aerosol generation apparatus is used as an example to briefly describe an internal structure thereof. Referring to FIG. 1, the aerosol generation apparatus includes a housing 10. From the outside, a mouthpiece 11 that is substantially flat is arranged at one end of the housing 10. During use of the aerosol generation apparatus, the mouth of a user is mainly in contact with the mouthpiece 11. Therefore, in a preferred implementation, the mouthpiece 11 is made of a material at a high safety level. In an optional implementation, the mouthpiece 11 and the housing 10 may alternatively be integrally formed. A bottom cover 12 is connected to an other end of the housing 10. Components in the housing 10 are mainly mounted through an exposure at the other end of the housing 10, and after the components are mounted, the bottom cover 12 is connected at the exposure of the housing 10.

An atomization assembly 20, a battery 51, an airflow sensing switch 52, and other components are mounted in the housing 10. A part of an inner cavity of the housing 10 is set as a liquid storage cavity 13 for storing a liquid substrate. The liquid storage cavity 13 is defined and formed by an independent liquid storage tube 131 provided in the housing 10. The liquid storage tube 131 is filled with a capillary element with excellent liquid storage performance, and the liquid substrate is stored in the capillary element. The capillary element includes fiber cotton. Further, the atomization assembly 20 is arranged in the inner cavity of the liquid storage tube 131, and the capillary element is arranged around the atomization assembly 20. An upper end cover 141 and a lower end cover 142 are separately connected to two ends of the liquid storage tube 131. The upper end cover 141 and the lower end cover 142 are in threaded connection to the liquid storage tube 131.

A part of the mouthpiece 11 is accommodated in the inner cavity of the housing 10. A mouthpiece port 110 is provided at one end of the mouthpiece 11. One end of the mouthpiece 11 accommodated in the inner cavity of the housing 10 abuts against the upper end cover 141, and the mouthpiece 11 has an air outlet chamber 111 in communication with the mouthpiece port 110 inside. An air outlet tube 15 is arranged at one end of the atomization assembly 20. A part of the air outlet tube 15 extends longitudinally in the liquid storage tube 131 and penetrates the upper end cover 141. An air outlet end of the air outlet tube 15 is in communication with the air outlet chamber 111 in the mouthpiece 11. An aerosol generated in the atomization assembly 20 can enter the air outlet tube 15, and be guided by the air outlet tube 15 to enter the mouthpiece 11, and inhaled by the user through the mouthpiece port 110. An other end of the atomization assembly 20 is fixed on the lower end cover 142. At least a part of the lower end cover 142 defines and forms an air inlet channel. External air enters the inner cavity of the atomization assembly 20 through the air inlet channel.

In the disposable aerosol generation apparatus, the atomization assembly 20 and the liquid storage tube 131 are accommodated in the inner cavity on an upper part of the housing 10, and a battery 51 and an airflow sensing switch 52 are mainly arranged in the inner cavity on a lower part of the housing 10. The atomization assembly 20 is electrically connected to the battery 51 and the airflow sensing switch 52. One end of the housing 10 away from the mouthpiece 11 is exposed, to facilitate mounting of components such as the liquid storage tube 131 and the battery 51. After the components in the housing 10 are mounted, the bottom cover is mounted at an exposed end of the housing 10. The airflow sensing switch 52 is mounted on the bottom cover 12. An air inlet is provided on the bottom cover 12. The external air enters the inner cavity of the housing 10 through the air inlet.

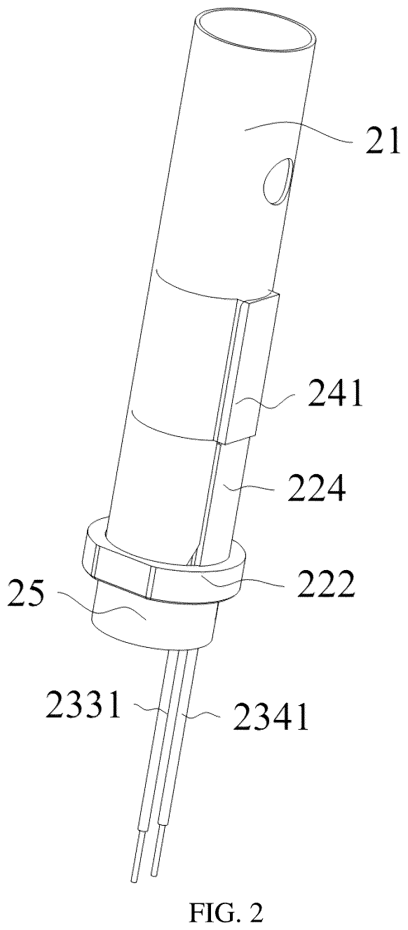

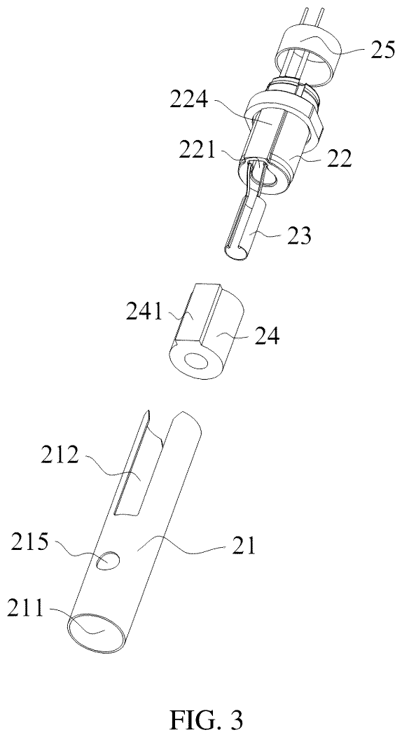

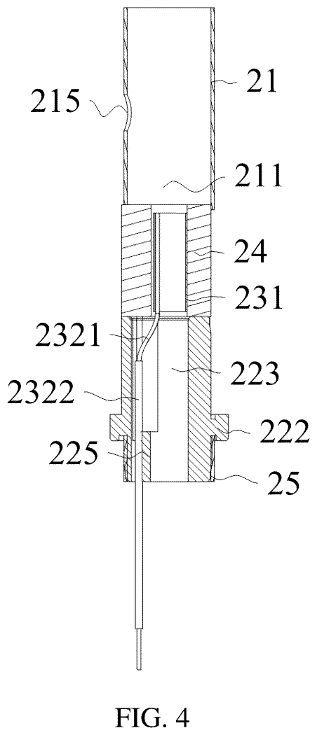

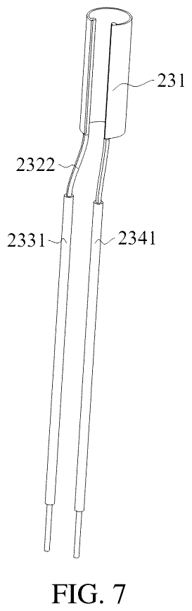

Referring to FIG. 2 to FIG. 7, the atomization assembly 20 includes a sleeve 21, an insulation base 22, a heating element, and a liquid guide element 24. The heating element 23 includes a heating portion 231 and a conductive portion 232. The conductive portion 232 is electrically connected to the power supply assembly, to supply power to the heating portion 231. In an example, referring to FIG. 7, the heating portion 231 is preferably made of a heating sheet with a mesh structure. Two conductive portions 232, namely, a first conductive portion 233 and a second conductive portion 234, are separately arranged at two ends of the heating sheet. The conductive portion 232 includes a conductive pin 2321 and a conductive lead 2322. An insulation sheath is sleeved outside a part of the conductive pin 2321 to form the conductive lead 2322. The heating sheet includes two free sides, namely, a first free side and a second free side. During mounting, the heating sheet encloses to form an unclosed tube-like structure. The two free sides of the heating sheet are connected to two conductive pins 2321. The first free side of the heating sheet is connected to a first conductive pin, and the second free side is connected to a second conductive pin. The two free sides of the heating sheet are spaced apart to prevent a short circuit due to contact between the first conductive pin and the second conductive pin.

The sleeve 21 has a hollow accommodating cavity 211. The heating portion 231 of the heating element 23 is accommodated in the accommodating cavity 211. One part of the conductive portion 232 on each side of the heating portion 231 is accommodated in the accommodating cavity 211, and the other part of the conductive portion 232 extends to an exterior of the accommodating cavity 211. The part of the conductive portion 232 extending to the exterior of the accommodating cavity 211 is mainly set in a form of the conductive lead 2322, to avoid a short circuit due to contact between the conductive portion 232 and other metal components or contact between the two conductive portions 232. The first conductive portion 233 includes a first conductive lead 2331, and the second conductive portion 234 includes a second conductive lead 2341.

The insulation base 22 is connected to an other end of the sleeve 21. The insulation base 22 is preferably made of a plastic material. A perforation 221 is provided on the insulation base 22, to fix the first conductive lead 2331 and the second conductive lead 2341 of the heating element 23. In an example provided in this application, only one perforation 221 is provided on the insulation base 22. The first conductive lead 2331 and the second conductive lead 2341 are fixed without being bent or pulled to outer sides of the two free sides of the heating portion 231, and can be kept relatively upright and relaxed to be inserted into the perforation 221. A distance between the first conductive lead 2331 and the second conductive lead 2341 is not greater than a distance between the two free sides of the heating sheet, so that a main portion of the heating sheet is always in a relaxed state in a process of fixing the first conductive lead 2331 and the second conductive lead 2341. In a preferred embodiment, the distance between the first conductive lead 2331 and the second conductive lead 2341 is equal to the distance between the two free sides of the heating sheet, so that the first conductive lead 2331 and the second conductive lead 2341 do not need to be positioned again with respect to the main portion of the heating sheet in the process of fixing, and relative positions between the main portion of the heating sheet and the liquid guide element 24 can be positioned according to a preset operation. It can be understood that if a positioned distance between the first conductive lead 2331 and the second conductive lead 2341 is greater than the distance between the two free sides of the heating sheet, during assembly, the first conductive lead 2331 and the second conductive lead 2341 need to be positioned again with respect to the heating portion 231 of the heating sheet. For example, the first conductive lead 2331 and the second conductive lead 2341 are bent and then fixed in the perforation 221 of the insulation base 22. The first conductive lead 2331 and the second conductive lead 2341 of the heating sheet are positioned again, to form an expanding tension on the heating portion 231 of the heating sheet, to distort a fixed shape of the heating sheet, so that an effect of transferring the liquid substrate between the liquid guide element 24 and the heating element 23 is affected, and local resistance of the heating portion 231 of the heating element 23 is affected, thereby affecting uniformity of the entire heating efficiency of the heating sheet.

A flange 222 extending circumferentially is provided on the insulation base. The flange 222 divides the insulation base into two sections, where a first section located above the flange 222 can be accommodated in the accommodating cavity 211 of the sleeve 21, and a fixing ring 25 is sleeved outside a second section located below the flange 222. In some embodiments, the fixing ring 25 is riveted on an outer wall of the second section of the insulation base 22, so that the conductive lead 2322, after being squeezed, can firmly run through the perforation 221 of the insulation base 22 without shaking. In other examples, after the first conductive lead 2331 and the second conductive lead 2341 run through the perforation 221 of the insulation base 22, the first conductive lead 2331 and the second conductive lead 2341 may alternatively be firmly positioned in the perforation 221 by using glue.

A through hole 223 is further provided on the insulation base 22, and the through hole 223 is in communication with the accommodating cavity 211 of the sleeve 21. An external airflow can enter the atomization assembly 20 through the through hole 223 of the insulation base 22. In a preferred embodiment, the perforation 221 is provided on one side of the through hole 223. A size of the perforation 221 is configured to accommodate two conductive leads 2322. Specifically, a raised rib 224 is provided on one side of the insulation base 22. An inner space of the rib 224 defines and forms the perforation 221. A raised height of the rib 224 is substantially determined by an inner diameter of the perforation 221. The rib 224 substantially includes two sections. A first section of the rib 224 is provided above the flange 222, and a second section of the rib 224 is provided below the flange 222.

The perforation 221 and the through hole 223 are both provided in the insulation base 22, and both extend by substantially the same distance in a longitudinal direction of the insulation base 22. Therefore, the perforation 221 is provided close to the through hole 223. In a preferred implementation, an axial projection region of the through hole 223 can substantially coincide with an axial projection region of an unclosed tubular space formed by the heating portion 231 of the heating element 23, and the perforation 221 is substantially flush with a spacing region between the two free sides of the heating portion 231 of the heating element 23 in a longitudinal direction, so that the conductive portion 232 of the heating element 23 can be kept relatively upright to be directly inserted into the perforation 221. To facilitate the conductive lead 2322 to run into the perforation 221 and be fixed in the perforation 221, only a separation wall 225 is arranged between the perforation 221 and the through hole 223. A part of the conductive pin 2322 located above the separation wall 225 can be kept relatively free to enter the perforation 221, and the separation wall 225 supports the conductive lead 2322, so that the conductive lead 2322 can be kept relatively upright to be fixed in the perforation 221. To facilitate the lead to run out of the perforation 221, two notches are provided at a bottom end of the perforation 221 of the insulation base 22. The notches are provided on two sides of the rib 224, and are located below the flange 222. To avoid position interference for the heating portion 231 of the heating element 23 caused by unfirm fixing of a lower end of the conductive lead 2322, after the conductive lead 2322 runs out of the perforation 221, the fixing ring 25 is riveted to a lower end of the flange 222 of the insulation base 22, so that the conductive lead 2322 can be firmly fixed in the perforation 221. Due to the fixing ring 25, the conductive lead 2322 is fixed in the perforation 221 without glue, and operations are easier and more convenient.

In a preferred implementation, the heating portion 231 of the heating element 23 encloses to form an unclosed and substantially tube-like atomization cavity. A central axis of the atomization cavity, a central axis of the accommodating cavity 211 of the sleeve 21, and a central axis of the through hole 223 of the insulation base 22 coincide. During mounting of the atomization assembly 20, accurate positioning of a central axis direction can be performed by using a substantially rod-like cotton-wrapped stick. An outer diameter of the cotton-wrapped stick is the same as the inner diameter of the through hole 223 of the insulation base 22.

The liquid guide element 24 is preferably made of fiber cotton. During mounting, the liquid guide element 24 is arranged at a periphery of the heating element 23. In some embodiments, the liquid guide element 24 is formed by several liquid guide cotton sheets. After the several liquid guide cotton sheets are stacked, the liquid guide cotton sheets enclose the periphery of the heating element 23, and two free sides of the liquid guide cotton sheets are kept together to form a protruding structure 241. The liquid guide element 24 is fixed through the protruding structure 241. In other embodiments, the liquid guide element 24 is a liquid guide body with a specific thickness. A hollow inner cavity is provided in the liquid guide element 24, and the heating element 23 is fixed in the inner cavity of the liquid guide element 24. A protruding structure 241 is provided on a side portion of the liquid guide body. The protruding structure 241 is also used for fixing the liquid guide element 24.

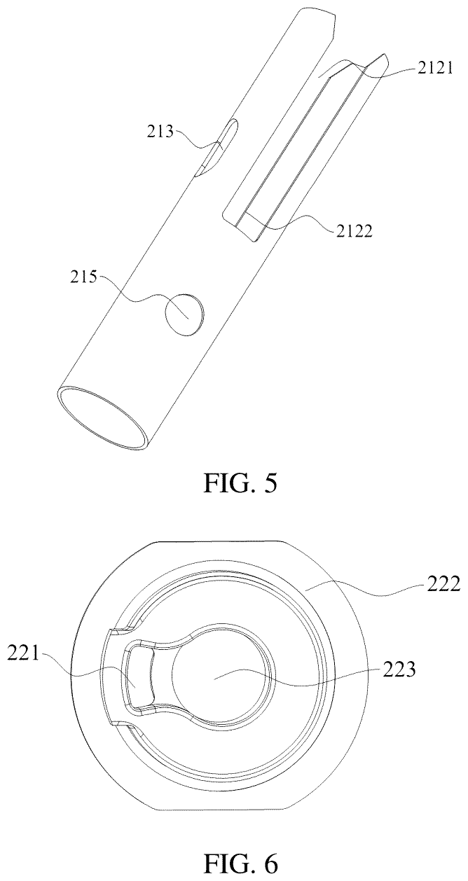

To facilitate the liquid guide element 24 with the specific thickness to be fixed in the sleeve 21 more easily, a U-shaped opening 212 is provided on the sleeve 21, so that the liquid guide element 24 can be inserted into the sleeve 21 through a side portion of the U-shaped opening 212. Further, the protruding structure 241 on the liquid guide element 24 is fixed on the U-shaped opening 212, and the liquid guide element 24 is in fluid communication with the liquid storage cavity 13 through the U-shaped opening 212. The sleeve 21 has a first end and a second end provided oppositely. The insulation base 22 is fixed at the second end of the sleeve 21. The U-shaped opening 212 extends longitudinally to the second end of the sleeve 21. In some embodiments, referring to FIG. 5, the sleeve 21 has a first opening 2121 and a second opening 2122 provided oppositely. Configurations of the first opening 2121 and the second opening 2122 enable the second end of the sleeve 21 to open at a specific angle, so that the sleeve 21 can be directly sleeved outside the liquid guide element 24.

An upper end of the liquid guide element 24 abuts longitudinally against an end portion of the U-shaped opening 212 of the sleeve 21, and a lower end of the liquid guide element 24 abuts longitudinally against an upper end surface of the rib 224 of the insulation base 22. A width of the rib 224 on the insulation base 22 is equal to a width of the opening 212 of the sleeve 21. A longitudinally extending length of the U-shaped opening 212 of the sleeve 21 is configured to fix the protruding structure 241 of the liquid guide element 24 and the first section of the rib 224 of the insulation base 22.

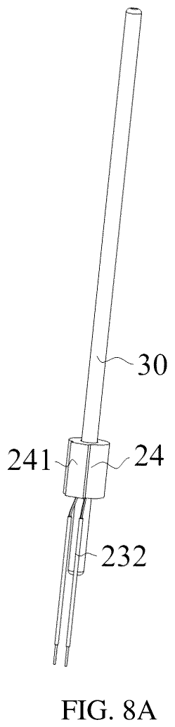

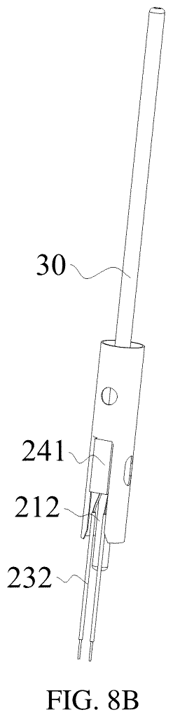

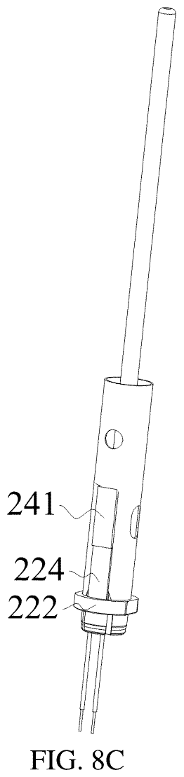

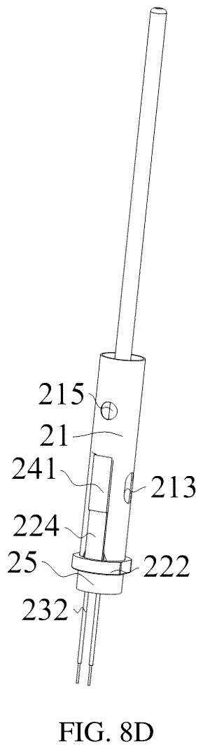

An embodiment of this application further provides an assembly method for a tubular atomization assembly 20. Refer to FIG. 8A to FIG. 8D:

Step 1, a sheet heating element 23 is disposed on a liquid guide element 24, a cotton-wrapped stick 30 is disposed on the heating element 23, and the cotton-wrapped cotton is wrapped with liquid guide cotton manually, to form a first assembly, as shown in FIG. 8A. The heating element 23 is placed at an intermediate position of the liquid guide element 24. A size of the cotton-wrapped stick is sufficiently large, so that the heating element 23 can only partially wrap the cotton-wrapped stick 30, and conductive portions 232 on two sides of the heating element 23 can attach to the cotton-wrapped stick 30.

Step 2, the first assembly is inserted from a U-shaped opening of a sleeve 21, until a protruding structure 241 of the liquid guide element 24 engages with the U-shaped opening 212 of the sleeve 21, to form a second assembly, as shown in FIG. 8B.

Step 3, the protruding structure 241 on the liquid guide element 24 of the second assembly is aligned with a rib 224 of an insulation base 22, until an end portion of the second assembly abuts against a flange 222 of the insulation base 22, to form a third assembly, as shown in FIG. 8C.

Step 4, a fixing ring 25 is riveted on the insulation base 22 of the assembly 3, as shown in FIG. 8D. In a riveting process, the fixing ring 25 squeezes the insulation base 22, to tightly press a conductive lead 2322, so that the conductive lead 2322 can be firmly positioned in the perforation 221.

In addition, because positioning is performed substantially based on structures of components in processes of the above steps, automated assembly can be implemented. A positioning hole 215 facilitating fixing a clamp for automated assembly may be provided on the sleeve 21.

After the assembly is completed, the atomization assembly 20 is mounted in the liquid storage tube 131 in the housing 10. After a sufficient liquid substrate fills the liquid storage tube 131, the cotton-wrapped stick 30 is taken out. In the entire mounting and assembly process of the atomization assembly 20, the heating portion 231 of the heating element 23 always wraps the cotton-wrapped stick 30, and the cotton-wrapped stick 30 can provide a radial support force for the heating element 23, so that a position of the heating element 23 can maintain relatively stable.

The liquid guide element 24 is in communication with the liquid substrate in the liquid storage tube through a first opening 2121 and a second opening 2122 on the sleeve 21. In some examples, a separate liquid inlet hole 213 is further provided on the sleeve 21, and is located between the first opening 2121 and the second opening 2122, to further increase contact ways between the liquid substrate and the liquid guide element 24. For a liquid substrate with poor fluidity, a plurality of liquid inlet holes 213 may be provided on the sleeve 21.

The conductive lead 2322 of the atomization assembly 20 may be directly electrically connected to a battery 51 and an airflow sensing switch 52 in a housing 10 of an aerosol generation apparatus. It can be understood that the atomization assembly 20 may also be used in an aerosol generation apparatus of a replaceable atomizer type. The atomization assembly 20 is mounted on the atomizer, an electrode column is arranged on a bottom cover 12 of the atomizer, and two conductive leads 2322 of the atomization assembly 20 are electrically connected to the electrode column.

When a length of the sleeve 21 of the atomization assembly 20 is sufficiently long, one part of a space of the sleeve 21 accommodates the heating element 23 and the liquid guide element 24, the other part of the space of the sleeve 21 forms an air outlet channel, and an other end of the sleeve 21 extends to an interior of an air outlet chamber 111 of a mouthpiece 11, to guide an aerosol to a mouthpiece port 110. When the length of the sleeve 21 of the atomization assembly 20 is short, one end of the sleeve 21 may be connected to an air outlet tube 15. The air outlet tube 15 may be sleeved outside the sleeve 21, or the air outlet tube 15 may be inserted into an inner cavity of the sleeve 21.

In the foregoing examples, the heating element 23 is set as a heating sheet. The liquid guide element 24 is arranged around the heating element 23. The heating element 23 and the liquid guide element 24 are fixed in the inner cavity of the sleeve 21 in a longitudinal direction of the housing 10. The conductive lead 2322 of the heating element is fixed on the insulation base 22 at the lower end of the sleeve 21. The perforation 221 is provided on the insulation base 22, and can accommodate two conductive leads 2322 at the same time, and the two conductive leads 2322 can be kept relatively relaxed to be inserted into the same perforation 221 without bending. The fixing of the conductive lead 2322 does not apply a pulling force to a main portion of the heating element 23, so that the heating element 23 can be fixed in the liquid guide element 24 in a predetermined manner. In other examples, the heating element 23 may alternatively be set as a heating wire. The heating wire is wound around the liquid guide element 24 that is substantially rod-like. Two ends of the heating wire are connected to conductive pins 2321. The conductive pins 2321 are fixed on the insulation base 22 at the lower end of the sleeve 21 in a form of the conductive lead 2322. Optionally, the liquid guide element 24 may alternatively be a ceramic tube. The heating element 23 is fixed in the inner cavity having the ceramic tube in a form of the heating wire or the heating sheet.

It should be noted that, the specification of this application and the accompanying drawings thereof illustrate preferred embodiments of this application, but this application is not limited to the embodiments described in the specification. Further, a person of ordinary skill in the art may make improvements or variations according to the foregoing descriptions, and such improvements and variations shall all fall within the protection scope of the appended claims of this application.

1. A tubular atomization assembly comprising:
a heating element comprising a heating portion and a conductive portion electrically connected to the heating portion, wherein the conductive portion comprises a first conductive portion and a second conductive portion and the heating portion is connected between the first conductive portion and the second conductive portion;
a sleeve having a hollow accommodating cavity, wherein the heating portion is accommodated in the accommodating cavity and at least a part of the conductive portion extends to an exterior of the accommodating cavity; and
an insulation base connected at one end of the sleeve, wherein the insulation base comprises a perforation, and the first conductive portion and the second conductive portion run through the perforation to be fixed on the insulation base.

2. The atomization assembly according to claim 1, wherein the atomization assembly further comprises a fixing ring around an exterior of the insulation base.

3. The atomization assembly according to claim 1, wherein:
the heating portion comprises a heating sheet with a mesh structure; and
the heating portion is constructed into an unclosed tubular structure.

4. The atomization assembly according to claim 3, wherein:
the first conductive portion comprises a first conductive lead, and the second conductive portion comprises a second conductive lead; and
the first conductive lead and the second conductive lead are positioned on the insulation base, and a distance between the first conductive lead and the second conductive lead is not greater than a distance between two free sides of the heating element.

5. The atomization assembly according to claim 4, wherein:
a spacing region is provided between the two free sides of the heating portion; and
the perforation is substantially flush with the spacing region in a longitudinal direction.

6. The atomization assembly according to claim 1, wherein at least one U-shaped opening is provided on a side surface of the sleeve.

7. The atomization assembly according to claim 6, wherein:
the opening comprises a first opening and a second opening that are spaced apart; and
at least one liquid inlet hole is further provided between the first opening and the second opening.

8. The atomization assembly according to claim 6, wherein:
a rib is provided on the insulation base; and
a size of the rib is configured to be inserted into the opening.

9. The atomization assembly according to claim 8, wherein the rib is located at a position on an outer surface of the insulation base corresponding to the perforation.

10. The atomization assembly according to claim 1, wherein:
the insulation base further comprises a through hole; and
the through hole is coaxially provided with the accommodating cavity.

11. The atomization assembly according to claim 10, wherein:
the perforation is provided on a side of the through hole; and
a separation wall is arranged between the through hole and the perforation.

12. The atomization assembly according to claim 6, further comprising a liquid guide element arranged at least partially around the heating element, wherein the liquid guide element comprises a protruding structure and the protruding structure is accommodated in the opening.

13. The atomization assembly according to claim 1, further comprising a liquid guide element arranged at least partially around the heating element, wherein the liquid guide element abuts longitudinally against the insulation base.

14. The atomization assembly according to claim 13, wherein:
the liquid guide element comprises a protruding structure; and
a size of the opening is configured to accommodate the protruding structure of the liquid guide element and at least a part of the rib of the insulation base.

15. The atomization assembly according to claim 1, wherein:
the insulation base comprises a flange; and
one end of the flange abuts against the sleeve.

16. The atomization assembly according to claim 15, wherein the fixing ring abuts against another end of the flange.

17. An assembly method for the atomization assembly according to claim 1, the assembly method comprising:
winding a heating element and a liquid guide element around a stick, to form a first assembly;
inserting the first assembly into an accommodating cavity of a sleeve from one end of the sleeve; and
connecting an insulation base to the same end of the sleeve, and accommodating two conductive portions of the heating element in a perforation of the insulation base.

18. The assembly method for the atomization assembly according to claim 17, further comprising riveting a fixing ring on the insulation base.

19. An aerosol generation apparatus comprising a housing, wherein a liquid storage cavity for storing a liquid substrate and an atomization assembly are arranged in the housing, the atomization assembly comprises the atomization assembly according to claim 1, and the atomization assembly atomizes the liquid substrate to generate an aerosol.

20. The atomization assembly according to claim 2, wherein the fixing ring is riveted on the insulation base.
